(19) United States
(12) Patent Application Publication
(10) Pub. No.: US 2007/0164133 A1
(43) Pub. Date: Jul. 19, 2007

(54) Low pressure gas accelerated gene gun

(76) Inventors: Hao-Jan Lin, Taipei (TW); Chien-Lung Chen, Tainan City (TW)

Correspondence Address: J.C. Patents, Inc., Suite 250, 4 Venture, Irvine, CA, 92618, US

(21) Appl. No.: 11/335,078

(22) Filed: Jan. 18, 2006

(51) Int. Cl. A62C 13/62; B05B 9/01; A62C 13/66

(52) U.S. Cl. 239/525; 239/526; 239/302

(57) ABSTRACT

The present invention relates to a gene gun and its application for genetic transformation, medical therapeutic or cosmetic purposes. Particular designs of the gene gun allow the biological materials to be delivered to the plant epidermal cellular tissues, the skin of an animal or human-being via a solution or a pre-mixed with the high pressure gas loading system. Moreover, the biological materials delivered by the gene gun are applied either in encapsulated nanoparticles or in the free form without using particle carriers.

### BACKGROUNDING OF THE INVENTION

1. Field of Invention

The present invention relates to a gene gun system. More particularly, the present invention relates to a gene gun system, wherein the gene gun system by using a low pressure gas flow is to accelerate the biological material in a solution form with or without carried by metal particles up to a high speed, and results in the penetration of the biological materials through the skin or epidermal tissues of animals, or plants, and the medical therapy or genetic transformation is accomplished hereafter.

2. Description of Related Art

Genetic transformation established by using particle gun, is known to transfer the genetic materials (e.g. DNAs) via micro or nano metal particles through the cellular membranes.

The acceleration of the DNA-coated micro or nano metal particles within a sample cartridge is conducted by the high gas pressure as well as the shock wave. When a preset high pressure is reached in the pressurized chamber, the sample cartridge containing DNA-coated particles is accelerated by a resulting shock wave and stopped against a screen. The DNA-coated particles sloughed off the sample cartridge pass through the screen and continue to be accelerated to bombard the target tissues due to the inertial movement. The major disadvantages of the aforementioned methods are the use of costly micro or nano metal particles as the DNA carrier and the cell damages caused by the shock wave.

### SUMMARY OF THE INVENTION

The gene gun of this invention can be applied to deliver various kinds of biological materials into the cell tissues. The present invention provides a gene gun, which uses a gas to directly accelerate biological materials in powder or in the solution form to a high speed, free of using metal particles. The biological materials can penetrate through the epidermal tissues and enter into the derma tissues for therapeutic or cosmetic purposes.

The present invention provides a gene gun, wherein the gene gun is applicable in biological material delivery and/or gene transformation. According to a preferred embodiment of the present invention, the contour design of the spray nozzle of the gene gun and modification of the material delivery system of the gene gun allows the gene gun to operate efficiently and deliver the biological material effectively. Without being carried by the metal particles, the biological materials can penetrate the epidermis or the cell/membrane/wall and enter into the cell or the organism.

In the present invention, the biological material, for example, DNAs, RNAs, proteins, virions or drugs, is prepared in the solution form and accelerated to enter into the cell for the delivery of drugs or gene transformation. Since the operation of the gene gun free of metal particles for carrying the biological materials, risks of altering the biological material are lowered and damages to the target cells are lessened.

It is to be understood that both the foregoing general description and the following detailed description are exemplary, and are intended to provide further explanation of the invention as claimed.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee. The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional display view of a gene gun according to a preferred embodiment of the present invention.

FIG. 2 is a cross-sectional display view of a sprayer and a spray nozzle according to a preferred embodiment of the present invention.

FIG. 3 is a cross-sectional display view for the contour design of the spray nozzle according to another preferred embodiment of this invention.

FIGS. 4A-4D are the cross-sectional display views of the material delivery system according to preferred embodiments of this invention.

FIG. 5 is the cross-sectional display view of the gene gun according to another preferred embodiment of this invention.

FIG. 6 shows magnified views (100×) of the abdominal epidermis cells of mice subjected to bombardment with fluorescein isothiocyanate (FITC)-labeled chitosan nanoparticle solution using the gene gun of the present invention and of the control mice.

FIG. 7 shows magnified views (100×) of the abdominal epidermis cells of mice subjected to bombardment with fluorescein-labeled hyaluronate (HA) solution using the gene gun of the present invention, the direct embrocation of fluorescein-labeled HA solution, and non-treatment as the control mice.

### DESCRIPTION OF THE PREFERRED EMBODIMENTS

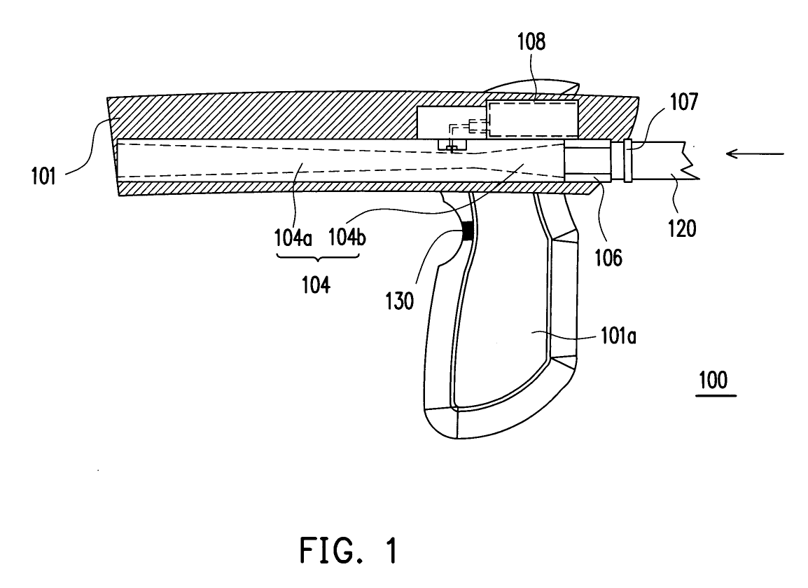

FIG. 1 is a cross-sectional display view of a gene gun 100 according to a preferred embodiment of the present invention. Referring to FIG. 1, the gene gun 100 of the present invention comprises at least a casing 101, a sprayer 104, a connector 106 and a material delivery system 108. The shape of the casing 101 can vary according to the operation requirements or the structural design and may comprise a handle structure 101a. The sprayer 104 is connected to the connector 106, while connector 106 is connected to the high pressure gas source 120 via the valve 107. The gene gun may include a chamber (not shown) disposed between the sprayer 104 and the connector 106 for pressure build-up, if necessary. The material delivery system 108 is connected to the sprayer 104. A gas (flow direction shown as arrow) is delivered from the connector 106 to the sprayer 104. The sample fluid or solution containing the biological materials is released into the sprayer 104 by the material delivery system 108. As the gas in sprayer 104 reaches a preset pressure, the high-pressure gas and the sample solution (or fluid) carried by the high-pressure gas are sprayed out through the sprayer 104.

The material of the sprayer 104 is made of biocompatible plastics, glass, quartz, a metal, or a metal alloy, for example. Preferably, the sprayer is made of stainless steel or quartz. The gene gun 100 may further comprise a trigger device 130 for triggering the release of the gas by controlling the on/off of the valve 107 and/or the release of the sample solution. The trigger device 130 may be disposed on the casing 101, preferably on the handle structure 101a. The gas source 120 for the gene gun 100 may be a helium gas, a nitrogen gas or other types of gas or air. Using helium gas is essential on animal or plant cells with a thicker keratin or wax layer. However, using a nitrogen gas for the gene gun is sufficient for the easily penetrated biological systems. The details of the supply and the control for the gas source 120 are known to one skilled in the art and will not be described herein.

In general, the sample fluid or solution (i.e. biological material containing fluid or solution) is accelerated by a gas to a velocity of sonic or subsonic gas flow (Me≦1). The sprayer 104 of this invention is designed to include at least a terminal spray tube 104a and a nozzle 104b. According to the theory of aerodynamics, as the pressure difference between the internal and the external of the spray nozzle is greater than 1.8 atm, a supersonic flow is generated. As shown in FIG. 1, if the cross-sectional diameter of the nozzle 104b converges initially and then diverges to a small degree, a supersonic flow is generated in the nozzle 104b. The gas velocity gradually decreases as the gas enters the spray tube 104a. By increasing the length of the spray tube 104a, the gas velocity decreases. The gas velocity can thereby be controlled within a certain limits according to the length of the spray tube 104a.

According to a preferred embodiment of the present invention, an appropriate design includes an application of sample fluid or solution without micro-carriers and a material delivery system as disclosed in the present invention. The sample fluid or solution can uniformly be accelerated to a required velocity without the application of high pressure, thus mitigating the damage to the target cells. Moreover, the contour design of the spray nozzle 104b and the spray tube 104a allows the pressure at the exit of the spray nozzle to approach the atmospheric pressure. Damages to the target cells are thereby reduced. According to one preferred embodiment of the present invention, the gene gun operation uses the sample fluid or solution without containing particle carriers in the solution, in combination of a special spray nozzle of the gene gun. In accordance of this special spray nozzle, the sample fluid or solution can be accelerated to different speeds by varying the length of the terminal spray tube and the type of gas source.

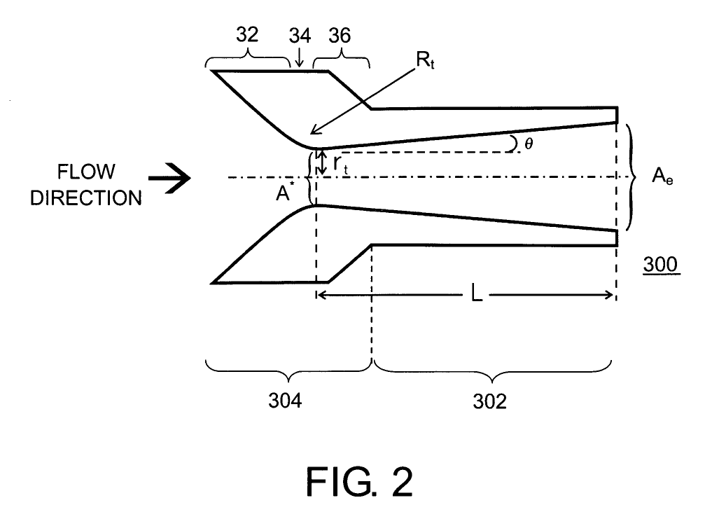

In order for the sample solution droplets to travel at a high speed, the present invention provides a high-speed sprayer 300, as shown in FIG. 2. Unlike the conventional straight spray tube, the spray tube 302 of the present invention is conical shape, allowing the speed of the gas flow to achieve the supersonic flow rate and the speed of the sample solution to approach the speed of sound. The spray nozzle 304 comprises a contour entrance, allowing the discharged sample solution to be more evenly distributed and are not localized at the exit, which causes cell death. Moreover, the gas pressure at the exit of the spray nozzle approaches atmospheric pressure to mitigate damages to the cell.

The spray tube and the spray nozzle of the present invention are designed according to the following theory:

Assuming the flow field is an isentropic flow, the ratio of the area of the spray nozzle (Ae) and the area of the spray neck A* is

$$\frac{Ae}{{A}^{*}} = \frac{1}{Me} {⌊ \frac{2}{γ + 1} ( 1 + \frac{γ - 1}{2} {Me}^{2} ) ⌋}^{\frac{γ + 1}{2 ( γ - 1 )}}$$

wherein, Me is the Mach number, which is a ratio of the gas flow rate over the speed of sound and γ is the specific heat ratio. If Me, Ae and γ are defined, A* is determined. Similarly, if the pressure P at the exit of the spray nozzle, the pressure in the pressurized chamber Po can also be determined according to the following equation

$$Po = {P ( 1 + \frac{γ - 1}{2} {Me}^{2} )}^{\frac{γ}{γ - 1}} .$$

FIG. 2 illustrates the contour design of the spray nozzle of the present invention according to one preferred embodiment of this invention. The spray nozzle 304 is designed to comprise a converging part 32 and a diverging part 36. The transition region between the converging part 32 and the diverging part 36 is the spray neck 34. The contour of the spray nozzle 304 is obviated from any abrupt transition to allow a smooth gas flow. The design of the spray nozzle 304 in FIG. 2 is a simplified version and the gas flow rate exiting the spray nozzle is not uniform. The general rule for the simplified design of the spray nozzle 304 is summarized as follows.

As shown in FIG. 2, Rₜ represents the curvature radius of the converging part 32 and rₜ is the radius of the spray neck 34, wherein rₜ<Rₜ<2Rₜ for the converging part of the simplified design. Θ, as shown in FIG. 2, is the angle between the diverging part 36 and center axis (broken lines) of the spray nozzle and the spray tube, wherein Θ is less than 15 degrees for the diverging part 36 of the simplified design. The contour of the converging part 32 of the spray nozzle 304, is a dwindling straight tube, forming a coned shape structure. The angle Θ between the slanted straight line and the center axis is less than 15 degrees, and is preferably between 10 to 15 degrees.

If the friction loss is ignored and the pressure at the converging part is high enough, the gas flow rate should achieve supersonic in the spray tube. Due to the diverging angle Θ of the spray tube, the slant shock wave caused by the supersonic gas flow can be avoided and the gas flow rate can remain supersonic. In general, if the contour of the spray tube is fixed, the expansion ratio of the gas flow and the Me (Mach number at the outlet) are determined.

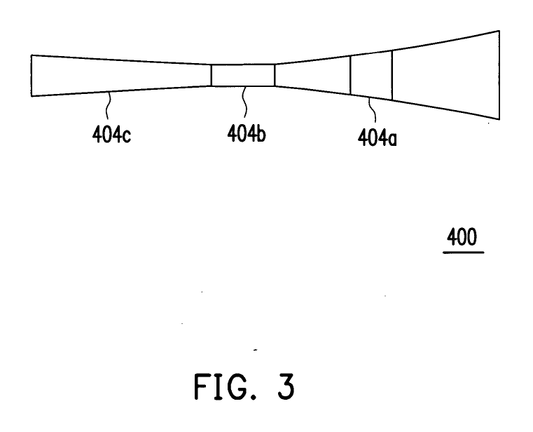

FIG. 3 illustrates the contour design of the spray nozzle according to another preferred embodiment of this invention. The sprayer 400 is designed to include two sets of the above design of the converging part, the neck and the diverging part. That is, the sprayer 400 can be considered to include two spray nozzles 404a, 404b with different contour designs. By adjusting the contour of the spray nozzle 404a (including Rₜ, rₜ for the converging part or Θ for the diverging part), the gas flow rate at the spray neck can achieve subsonic or sonic (M≦1). Furthermore, as the contour of the spray nozzle 404b (including Rₜ, rₜ for the converging part or Θ for the diverging part) is carefully designed, the gas flow rate, after passing the spray nozzle 404b, at the exit of the spray tube 404c achieves supersonic (M>1).

Since the gas flow rate achieves supersonic at the exit of the spray nozzle, a coned shape spray tube or a straight spray tube is connected to the spray nozzle to accelerate the sample to a high speed, which is proven to be effective in penetrating into the epidermis cell, through the cell wall and/or the cell membrane.

The design of the material delivery system varies according to the operation requirements. As exemplified, a mechanism based on Venturi effect is employed, so that droplets of the sample solution are drawn from the material delivery system. The sample solution droplets are then carried away by the high velocity gas flow and are discharged at a high speed into the target tissue.

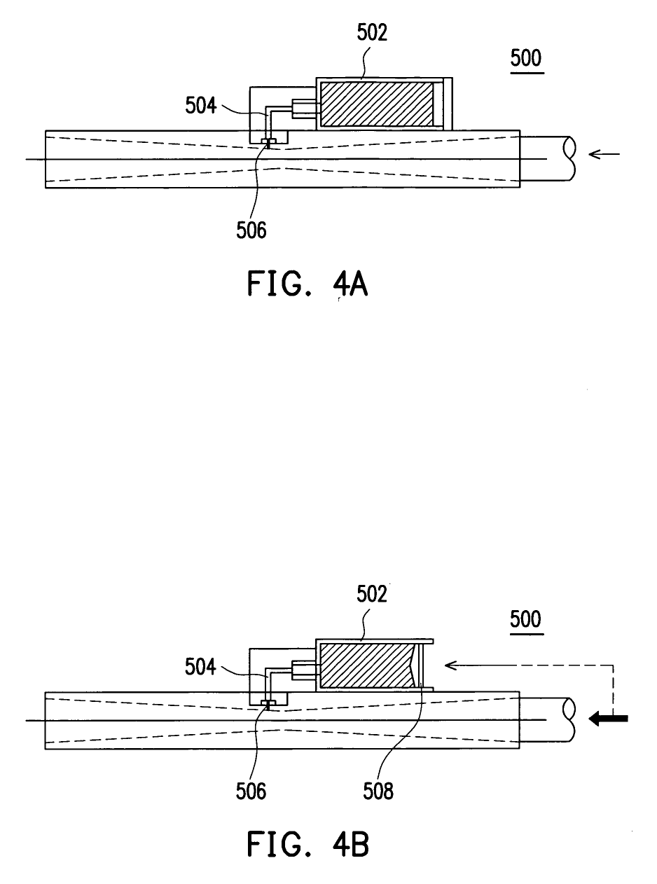

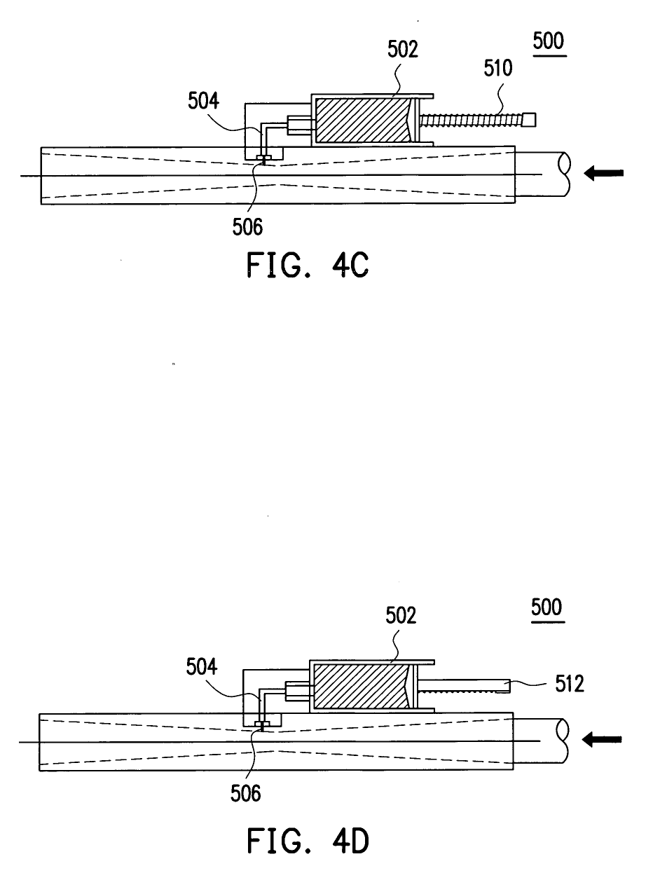

FIGS. 4A-4D are the cross-sectional display views of the material delivery system according to preferred embodiments of this invention. As shown in FIG. 4A, the sample solution can be stored in a container 502 of the material delivery system 500. The sample solution flows through the channel 504 that connects the container 502 and the outlet 506 and the sample solution is released through the outlet 506 around the spray neck. The container 502 can be replaceable and tight-fitted to the channel 504, for example. Similar to the air-fuel mixing mechanism used in the carburetors, the sample solution droplets are sucked from the material delivery system 500 and then carried by the gas flow. Based on Bernoulli's principle, the moving air has a lower pressure than the still air, and the faster the movement of the air, the lower the pressure. Due to the high velocity of the gas flowing through the sprayer (flow direction shown as the arrow), especially at the spray neck (the narrowest part), the gas produces partial vacuum and thus draws the sample solution from the material delivery system 500. In general, by adjusting the amount or speed of the gas flowing through the sprayer, the released amount of sample materials can be controlled. Usually, faster flows of the gas draw more sample solution into the sprayer due to the larger partial vacuum generated.

Alternatively, a controller can be incorporated into the container 502 of the material delivery system 500 to accurately control or adjust the released amount of the sample solution; especially if the release amount of the sample solution is minute (e.g. smaller than 0.1 ml). As shown in FIG. 4B, the backend of the container 502 is open and a plunger 508 is fitted to the container 502. Through the plunger 508, a gas flow (the flow direction shown as the arrow) ramified from the gas source is applied to push the plunger 508 and transfer a specific amount of the sample solution into the channel. The controller may further comprise a feeding screw 510 as shown in FIG. 4C, or a push rod 512 as shown in FIG. 4D disposed on the plunger 508, and the feeding screw 510 or push rod 512 can be either manually or electrically pushed to transfer a specific amount of the sample solution into the channel. The controller can control the release of the sample solution in sessions or adjust the amount of the sample solution to be released in several portions. The above mechanism is suitable for delivering the solution containing the biological materials.

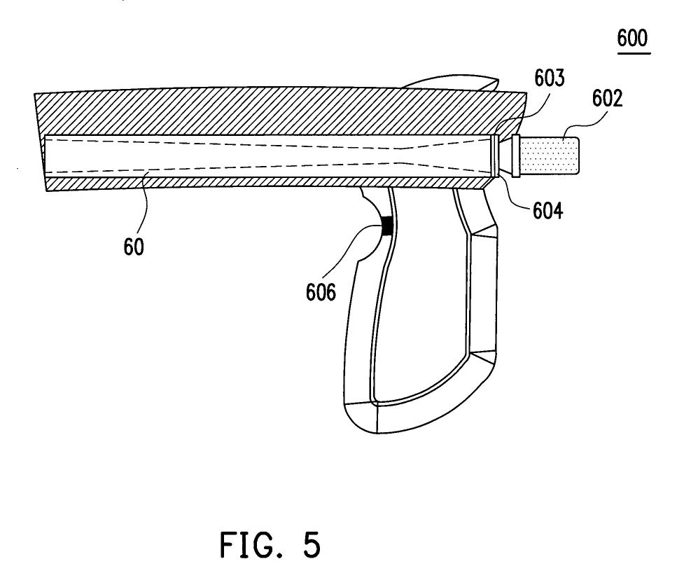

Alternatively, the gene gun can be designed to deliver the sample materials (i.e. biological materials) pre-mixed with the gas. As shown in FIG. 5, the sample material (either in powered form or dissolved in solution) is stored in a container 602 and mixed with a high pressure gas. In this case, the gas source and the pressurized chamber are not required and replaced by the container 602. Before shooting, the container 602 is connected to the sprayer 60 through a connector 603. During operation, the pressure valve 604 is open and the sample materials along with the high pressure inert gas are released and flow into the sprayer 60. The high-velocity gas flow (flow direction as shown in arrow) resulted from the high pressure inert gas would carry the sample materials and the sample materials are further accelerated to the required velocity by the sprayer 60. A trigger device 606 may be included to set off a signal to open the pressure valve 604 and further control the switch time of the valve. The trigger device is not limited to any single type of technology or assembly and any existing assembly or technology for the trigger device can be used. Since the trigger device is not the essential feature of the present invention, details will not be reiterated.

By using the present invention, a variety of biological materials, such as RNAs, DNAs, peptides, saccharides, virions, or chemical drugs, can be delivered via the skin route and enter deeply into the dermal layer for therapeutic, or cosmetic purposes. In the case of the genetic materials, the therapy is performed by the transient expression of the functional peptides in the cytoplasma through either the bombardment of encapsulate nanoparticles or cellular endocytosis into the cells.

It is intended that the specification and examples to be considered as exemplary only. Additional advantages and modifications are readily occurred to those skilled in the art from the consideration of the specification and the practice of the invention disclosed herein.

Preparation of FITC-Labeled Chitosan Nanoparticles

Fluorescein isothiocyanate (FITC) is the most commonly-used fluorescent dye for histochemical analysis. Fluorescein is typically excited by the 488 nm argon laser, and its emission is measured at 530 nm. 100 mg FITC (Sigma) is dissolved in 150 ml of dehydrated methanol (Aldrich), and the obtained solution is added to 0.1M acetic acid solution of 1% (wt.) chitosan (MW=8.0×10⁴, from Chin-Ming Chemical Inc.). After reacting the mixture in the dark for three hours, 0.1 M NaOH is used to adjust the pH to about 8˜9 to precipitate the resultant FITC-labeled chitosan. Following dialysis in the dark for three days, the un-reacted FITC is removed and FITC-labeled chitosan precipitate is re-dissolved in 80 ml of 0.1M acetic acid solution. After repeated centrifugation (40,000×g, 10 min) washes by water, the FITC-labeled chitosan precipitate is vacuum dried and collected.

Bombardment of Mouse Skin with FITC-Labeled Chitosan Nanoparticles Solution.

The specimen used for the gene gun experiment is three to four-week-old BALB/c mice. Hair at the abdomen of the mouse is shaved to expose the skin of the mouse, and then surface-sterilized with 70% alcohol. After filling FITC-labeled chitosan nanoparticles solution into the container of the gene gun, bombardment is performed to the exposed mice skin, setting the pressure of the gene gun being 70 psi and the switch time of the valve being 0.6 second. The size of the abdominal skin for each mouse can take several shots of bombardment, with each shot in a volume of 60 μl. After one hour, the mice were sacrificed to remove the skin for observation under confocal laser scan microscopy (CLSM) Leica TCPSL.

Preparation of Fluorescein-Labeled Hyaluronate (HA) by Ugi Reaction

(as reference to Chunxun Zeng et. al., 1998 “Inhibition of Tumor Growth In vivo by Hyaluronan Oligomers” Int. J. Cancer: 77, 396-401.)

Fluoresceinamine (Aldrich) is dissolved in methanol (Aldrich) in a concentration of 3.8 mg/ml for the preparation of fluoresceinamine-methanol solution. 10 ml of fluoresceinamine-methanol solution is drop-by-drop added into 135 ml of 4.4 mg/ml aqueous hyaluronate (MW=1.7×10⁶) solution under constant agitation. To the mixture solution, 15 ml of 46 mM cyclohexylisocyanide (Aldrich) solution (in methanol) and 5 ml of 0.25 M aqueous acetaldehyde solution (Fluka) were added, and dark brown precipitate is formed. The precipitate is then stirred for 45 minutes. Three volumes of absolute ethanol were then poured into the solution and the precipitate is collected by centrifugation. The yellowish precipitate is washed three times with ethanol and then vacuum dried to give 550 mg fluorescein-labeled HA. Fluorescein-labeled HA is then re-suspended in water in a concentration of 5 mg/ml and stored at 4° C.

Bombardment of Mouse Skin with Fluorescein-Labeled HA Solution.

Similar to the bombardment procedure with FITC-labeled chitosan solution, mice are shaved to expose the abdominal skin, and then sterilize with 70% alcohol. After filling fluorescein-labeled HA solution into the container of the gene gun, bombardment is performed to the exposed mice skin, setting the pressure of the gene gun being 70 psi and the switch time of the valve being 0.6 second. The size of the abdominal skin for each mouse can take several shots of bombardment, with each shot in a volume of 60 μl. After one hour, the mice were sacrificed to remove the skin for observation under confocal laser scan microscopy (CLSM) Leica TCPSL. In order to compare the results of administrating fluorescein-labeled HA through gene gun bombardment and through directly applying fluorescein-labeled HA to the skin without the gene gun bombardment, 100 μl of fluorescein-labeled HA solution is embrocated directly to the abdominal skin. After one hour, the mouse is sacrificed to remove the skin for observation under confocal laser scan microscopy (CLSM) Leica TCPSL.

Results from the Bombardment of the Gene Gun

Bombardment with FITC-Labeled Chitosan Nanoparticle Solution

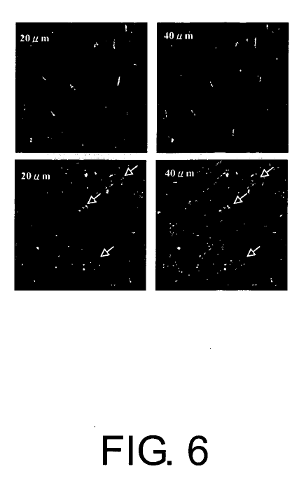

The green fluorescence present on the abdominal epidermis cells of the mice is observed under CLSM. As shown in FIG. 6 (100 times magnified, 100×), the top two image show abdominal epidermis cells of the control mice (without gene gun bombardment) respectively in the observed depth of 201 μm and 40 μm, emitting very dim green fluorescence. On the other hand, as shown in FIG. 6, the bottom two images show abdominal epidermis cells of the tested mice (bombarded with FITC-labeled chitosan nanoparticle solution) respectively in the observed depth of 20 μm and 40 μm, emitting green fluorescence (indicated in arrows). This indicates that the bombardment of the gene gun indeed transfers FITC-labeled chitosan nanoparticles into the epidermis cells of the mice.

Bombardment with Fluorescein-Labeled HA Solution

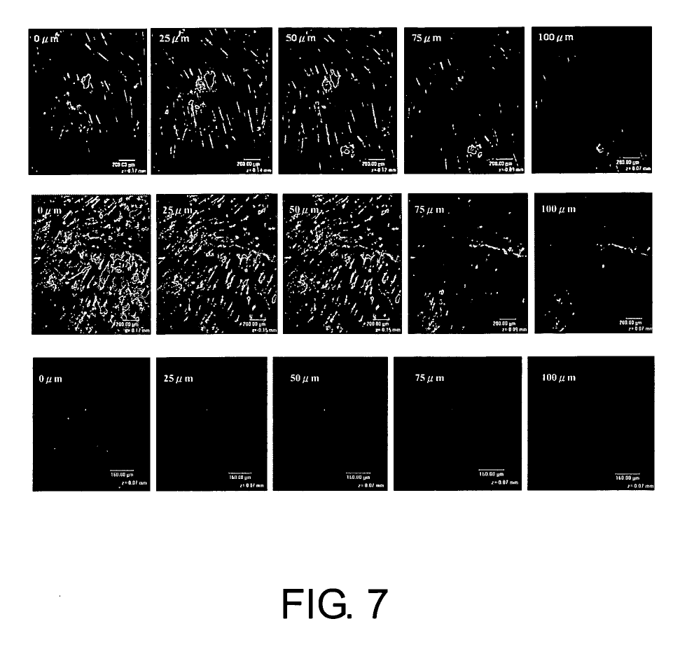

The green fluorescence present on the abdominal epidermis cells of the mice is observed under CLSM. As shown in FIG. 7 (100 times magnified, 100×), the images of the bottom row images show abdominal epidermis cells of the control mice (without gene gun bombardment or topical application) respectively in the observed depth of 0 μm, 25 μm, 50 μm, 75 μm and 100 μm, emitting no green fluorescence. Still referring to FIG. 7, the images in the top row show abdominal epidermis cells of the tested mice (bombarded with fluorescein-labeled HA solution) respectively in the observed depth of 0 μm, 25 μm, 50 μm, 75 μm and 100 μm, emitting green fluorescence (indicated in arrows). This indicates that bombardment of the gene gun successfully transfers fluorescein-labeled HA solution into the epidermis cells of the mice, distributed from the surface (0 μm) to the depth of 100 μm. The images of the middle row in FIG. 7 show abdominal epidermis cells of the mouse with directly embrocation of fluorescein-labeled HA solution, emitting green fluorescence in the observed depth of 0 μm, 25 μm and 50 μm. However, very dim fluorescence is observed for the depth of 75 μm or 100 μm, indicating the penetration of fluorescein-labeled HA through direct embrocating is superficial and less effective.

Accordingly, the design of the gene gun allows the gene gun to operate at a low pressure and accelerate the sample solution to a high speed and successfully transfer the biological materials into the epidermis or the cell/membrane/wall and enter into the cell or the organism without being carried by the metal particles.

Since a low pressure is used, the biological materials are delivered into the cell without using metal particles, to achieve gene transformation with minimal damages to the cells. Moreover, since the sample of this invention is prepared in the solution form without using metal particles, the operation of the gene gun is easy and straightforward, disregarding the difficulties conventionally encountered in the preparation of the gold particles. In the present invention, the biological material, for example, DNAs, RNAs, proteins, virions or drugs, is prepared in the solution form and accelerated to enter into the cellular tissues for drug delivery or gene transformation.

Moreover, due to the contour design of the spray nozzle, the operation of the gene gun is modified to allow an even distribution of the sample solution. Since the pressure at the nozzle opening is close to atmospheric pressure, the target cell is prevented from being damaged.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A low pressure gene gun, comprising:
a gas source to provide a gas;
a gene gun apparatus, wherein the gene gun apparatus comprises at least:
a sprayer, wherein the sprayer includes a spray nozzle and a spray tube, and the spray nozzle comprises a front part and a back part, the front part of the spray nozzle is connected to the spray tube and the back part of the spray nozzle is connected to a connector, wherein an interior contour of the spray nozzle comprises a diverging part, a converging part and a spray neck positioned between the diverging part and the converging part;
the connector connected to the back part of the spray nozzle and to the gas source through a valve, wherein the gas flows from the gas source and enters into the back part of the spray nozzle;
a material delivery system connected to the sprayer, wherein the material delivery system comprises at least a container for storing a sample solution, wherein the container is connected to the spray neck of the sprayer through a channel and the sample solution is delivered to the sprayer through the channel and an outlet at the spray neck;
a casing, enclosing at least the sprayer; and
a trigger device disposed on the casing, for triggering and controlling a release of the gas, allowing the sample solution to be sprayed from the sprayer.

2. The low pressure gene gun of claim 1, wherein the spray tube is a diverging straight or conical tube.

3. The low pressure gene gun of claim 1, wherein a range of the converging part of the spray nozzle includes: rₜ<Rₜ<2Rₜ, wherein Rₜ represents a curvature radius of the converging part, and rₜ is a radius of the spray neck; and
Θ<15 degrees, wherein Θ is an angle between the diverging part and a center axis of the interior contour of the spray nozzle.

4. The low pressure gene gun of claim 1, wherein the material deliver system further comprises a plunger fitted to the container for delivering a predetermined amount of the sample solution into the channel.

5. The low pressure gene gun of claim 4, wherein the plunger is pushed by a ramified gas flow from the gas source.

6. The low pressure gene gun of claim 4, wherein the material deliver system further comprises a feeding screw incorporated with the plunger.

7. The low pressure gene gun of claim 4, wherein the material deliver system further comprises a push rod incorporated with the plunger.

8. The low pressure gene gun of claim 1, wherein the gas includes air, a nitrogen gas or a helium gas.

9. The low pressure gene gun of claim 1, wherein the container is replaceable and tight-fitted to the channel.

10. The low pressure gene gun of claim 1, wherein a material of the sprayer is quartz.

11. The low pressure gene gun of claim 1, wherein a material of the sprayer is a metal or a metal alloy.

12. A low pressure gene gun, comprising:
a container comprising a sample material pre-mixed with a high pressure gas;
a connector, connected to the container through a valve;
a sprayer, connected to the connector, wherein the sprayer includes a spray nozzle and a spray tube, and the spray nozzle comprises a front part and a back part, the front part of the spray nozzle is connected to the spray tube and the back part of the spray nozzle is connected to the container, wherein an interior contour of the spray nozzle comprises a diverging part, a converging part and a spray neck positioned between the diverging part and the converging part;
a casing, enclosing the container and the sprayer; and
a trigger device disposed on the casing, for triggering an open of the valve and controlling a release of the gas and the sample material, allowing the gas to flow through the sprayer and the sample material to be sprayed from the sprayer.

13. The low pressure gene gun of claim 12, wherein the spray tube is a diverging straight or conical tube.

14. The low pressure gene gun of claim 12, wherein a range of the converging part of the spray nozzle includes: rₜ<Rₜ<2Rₜ, wherein Rₜ represents a curvature radius of the converging part, and rₜ is a radius of the spray neck; and
Θ<15 degrees, wherein Θ is an angle between the diverging part and a center axis of the interior contour of the spray nozzle.

15. The low pressure gene gun of claim 12, wherein the gas includes air, a nitrogen gas or a helium gas.

16. The low pressure gene gun of claim 12, wherein the container is replaceable.

17. The low pressure gene gun of claim 12, wherein a material of the sprayer is quartz.

18. The low pressure gene gun of claim 12, wherein a material of the sprayer is a metal or a metal alloy.
